(19) United States
(12) Patent Application Publication
(10) Pub. No.: US 2017/0227366 A1
(43) Pub. Date: Aug. 10, 2017

(54) Automated Vehicle Map Updates Based On Human Verification

(71) Applicant: Delphi Technologies, Inc., Troy, MI (US)

(72) Inventors: Michael H. Laur, Mission Viejo, CA (US); John P. Absmeier, Capitola, CA (US); Anthony Nguyen, Fremont, CA (US)

(21) Appl. No.: 15/040,250

(22) Filed: Feb. 10, 2016

(51) Int. Cl. G01C 21/32; G05D 1/00

(52) U.S. Cl. CPC G01C 21/32; G05D 1/0088

(57) ABSTRACT

A map-update system to update maps used by an automated vehicle includes an object-detection-device, an operator-communication-device, and a controller. The object-detection-device is used to detect objects proximate to a vehicle. The operator-communication-device is used to communicate an inquiry to an operator and detect a response from the operator. The controller is in communication with the object-detection-device and the operator-communication-device. The controller is configured to navigate the vehicle in accordance with a digitized-map, determine when an object detected by the object-detection-device does not correspond to an expected-feature present in the digitized-map, output an inquiry regarding the object to the operator via the operator-communication-device, and update the digitized-map based on the response from the operator.

### TECHNICAL FIELD OF INVENTION

This disclosure generally relates to a digitized-map update system, and more particularly relates to using an operator of an automated vehicle to provide a confirmation of the absence or presence of objects indicated on a digitized-map, or to classify newly detected objects that are not indicated on the digitized-map.

### BACKGROUND OF INVENTION

Many fully-automated (i.e. autonomous) vehicles rely on detailed digitized-maps of roadways that indicate the locations of objects such as traffic-signals, roadway-signs, lane-markings, buildings, and the like relative to a travel-path suitable for the vehicle. It is recognized that objects may be added, removed, or relocated for a variety of reasons. For example, a lane may be added, lane-markings revised, a traffic-signal relocated, or a building may be constructed or razed. The result may be that the digitized-map no longer corresponds to the surrounding about a vehicle, and disciplined/reliable updating of the digitized map by a government road-commission is not expected.

### SUMMARY OF THE INVENTION

In accordance with one embodiment, a map-update system to update maps used by an automated vehicle is provided. The system includes an object-detection-device, an operator-communication-device, and a controller. The object-detection-device is used to detect objects proximate to a vehicle. The operator-communication-device is used to communicate an inquiry to an operator and detect a response from the operator. The controller is in communication with the object-detection-device and the operator-communication-device. The controller is configured to navigate the vehicle in accordance with a digitized-map, determine when an object detected by the object-detection-device does not correspond to an expected-feature present in the digitized-map, output an inquiry regarding the object to the operator via the operator-communication-device, and update the digitized-map based on the response from the operator.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a map-updating system in accordance with one embodiment; and

FIG. 2 is an illustration of a traffic scenario experienced by the system of FIG. 1 in accordance with one embodiment.

### DETAILED DESCRIPTION

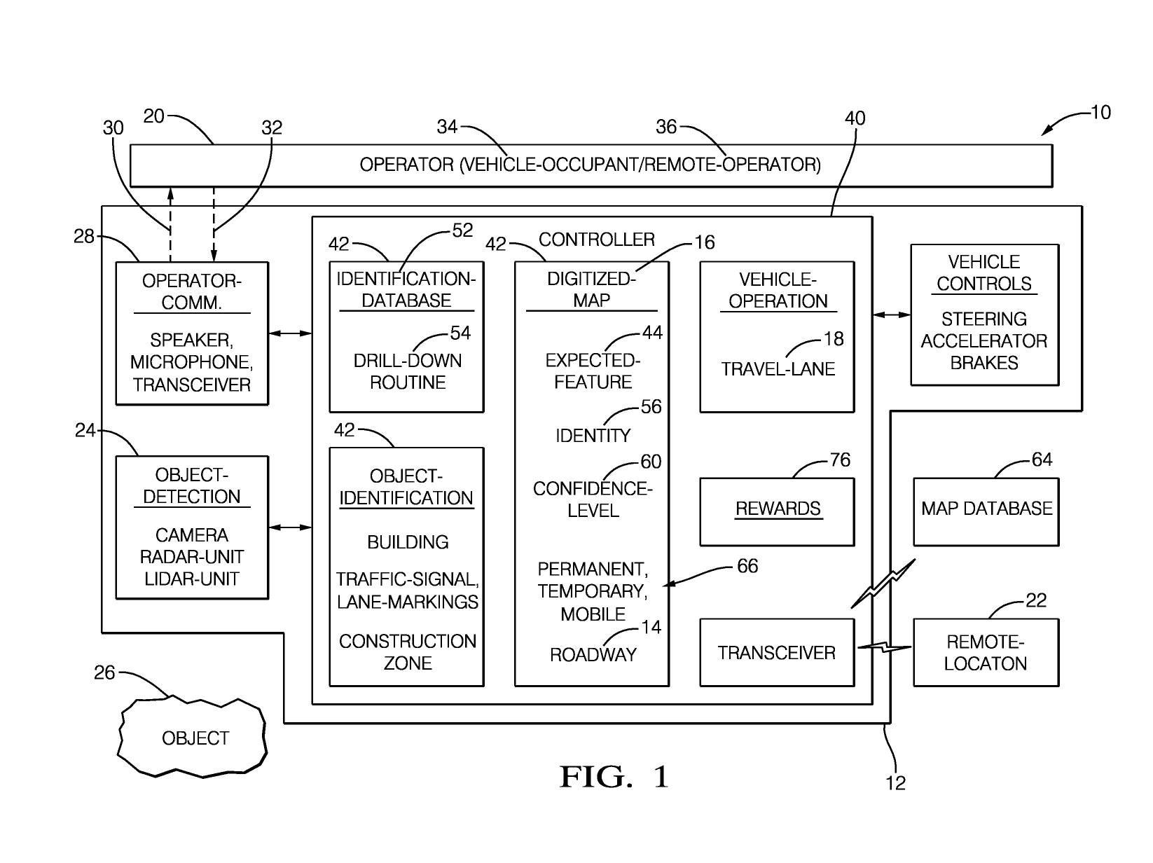

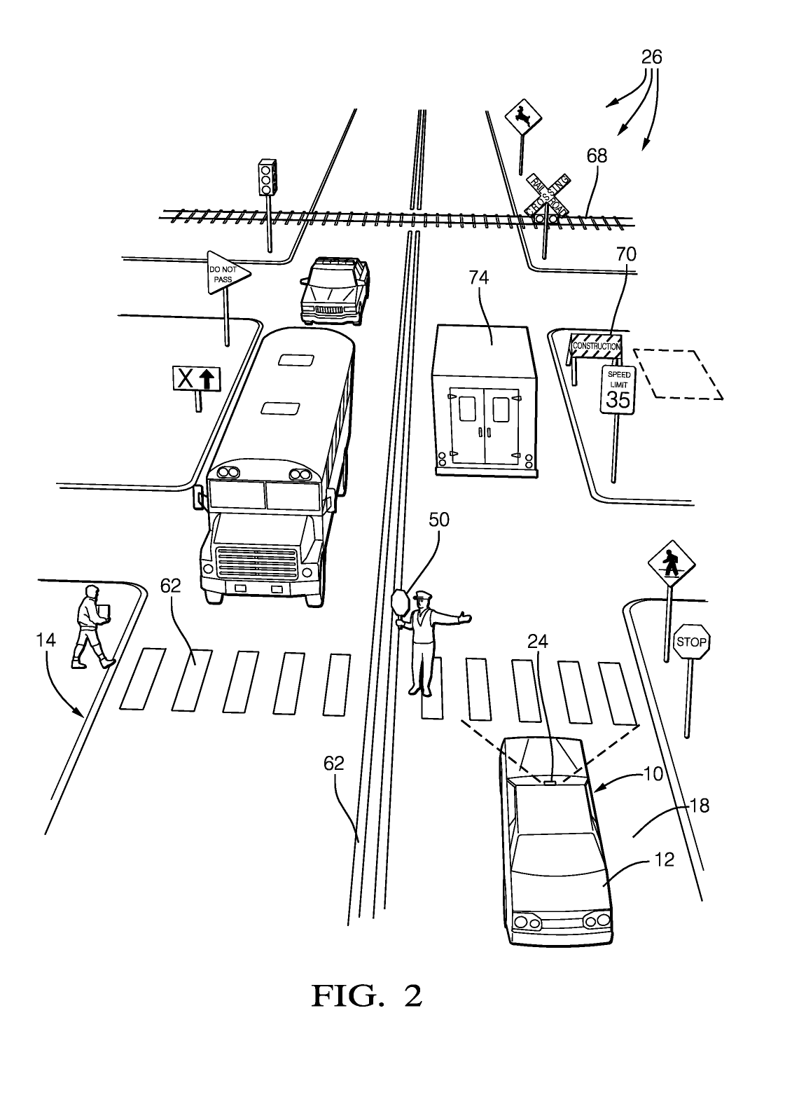

FIGS. 1 and 2 illustrate non-limiting examples of a map-update system, hereafter referred to as the system 10. The system 10 is suitable for use in an automated vehicle (the vehicle 12), and a roadway 14 traveled by the vehicle 12. In general, the system 10 is configured to update a digitized-map 16 used by the vehicle 12 for operation (e.g. steering, braking, and acceleration) of the vehicle 12 along a travel-lane 18 of the roadway 14. While the description presented herein is generally directed to a fully automated or autonomous vehicle where an operator 20 is generally not directly involved with controlling the steering, acceleration, and braking of the vehicle 12, it is contemplated that the teachings presented herein are useful for vehicles with varying degrees of automation, including a manually driven vehicle where a navigation means makes use of the digitized-map 16 of the map-update system to merely provide route guidance information to the operator 20 of the vehicle 12. While FIG. 2 might be interpreted to suggest that the system 10 is located entirely with the vehicle 12, it is contemplated that portions of the system may be located apart from the vehicle 12 at, for example a remote-location 22. Non-limiting details of what aspects of the system 10 may be off-vehicle will be described in more detail below.

As used herein, the digitized-map 16 may include, but is not limited to, previously stored information as well as real-time collected information that is used to identify objects and simple or complex features of the driving environment suitable to assist with navigation, localization, object recognition, and or vehicle to object (e.g. infrastructure or V2I) communication. The digitized-map 16 may include information about a feature or object of the driving environment, and the location of that feature or object, as well as information for recognizing and communicating with a particular object such as traffic-control-signal. The digitized-map 16 may be used by and/or compared to other digitized maps created by, for example, GPS, LiFi, WiFi, DSRC, RF, Lidar, Radar, Sonar, and/or camera.

The system 10 includes an object-detection-device 24 used to detect one or more instances of an object 26 proximate to the vehicle 12. As used herein, the object 26 may be, but is not limited to, any instance of a person, vehicle, sign, lane-marking, building, or other-object shown in FIG. 2 or anything that could be included in FIG. 2. As will be recognized by those in the art, the object-detection-device 24 may include, but is not limited to, a camera, a radar-unit, a lidar-unit, or any combination thereof.

The system 10 also includes an operator-communication-device 28 used to communicate an inquiry 30 to the operator 20, and detect a response 32 from the operator 20. As will be explained in more detail later, the inquiry 30 is generally intended to ask or query the operator 20 about the object 26, and the system 10 uses the response 32 to, for example, update the digitized-map 16. As one non-limiting example, the operator 20 may reside inside the vehicle 12, i.e. the operator 20 may be a vehicle-occupant 34, so the operator-communication-device 28 may consist of a speaker to output the inquiry 30, and a microphone to detect the response 32. Alternatively, if the vehicle-occupant 34 is wearing a communication-device such as a wireless-device used to operate a smart-phone, the operator-communication-device 28 may include a transceiver suitable to communicate with the wireless-device. By way of another example, the operator 20 may be at the remote-location 22, so the transceiver may be a cellular-phone type of transceiver so long-distance (e.g. more than 100 meters) communication between a remote-operator 36 of the vehicle and the vehicle 12 itself is enabled. Then, even though the vehicle 12 is empty (i.e. no passengers), the remote-operator 36 can be queried about, for example, the identity, presence, or absence of the object 26 in an image captured by the camera in the object-detection-device 24.

The system 10 also includes a controller 40 in communication with the object-detection-device 24 and the operator-communication-device 28. The controller 40 may include a processor (not specifically shown) such as a microprocessor or other control circuitry such as analog and/or digital control circuitry including an application specific integrated circuit (ASIC) for processing data as should be evident to those in the art. The controller 40 may include memory 42, including non-volatile memory, such as electrically erasable programmable read-only memory (EEPROM) for storing one or more routines, thresholds, and captured data. The one or more routines may be executed by the processor to perform steps for analyzing signals received by the controller 40, as will be described in more detail below. While FIG. 1 suggests that the memory 42 is on-vehicle, i.e. part of the controller 40, it is contemplated that off-board memory (i.e. memory in the cloud) may be provided to store the digitized-map 16 as part of a map database 64.

In one embodiment, the controller 40 is configured to navigate the vehicle 12 in accordance with the digitized-map 16, determine when the object 26 detected by the object-detection-device 24 does not correspond to an expected-feature 44 present in the digitized-map 16, output the inquiry 30 regarding the object 26 to the operator 20 via the operator-communication-device 28, and update the digitized-map 16 based on the response 32 from the operator 20. As used herein, ‘correspond’ means that what is detected by the object-detection-device 24 either does not match with any instance of the expected-feature 44 in the digitized-map 16, or some instance of the expected-feature 44 in the digitized-map 16 is not detected by the object-detection-device 24. Updates to the digitized-map 16 are made when, for example, a new object is detected that is not on the digitized-map 16, and when an instance of the expected-feature 44 is detected at a new location or has otherwise changed, e.g. exhibits a new or different size.

FIG. 2 illustrates multiple examples of when an object detected by the object-detection-device may not correspond to an expected-feature present in the digitized-map 16. For example, a traffic-officer 50 may be standing stationary in the roadway 14. The traffic-officer 50 likely does not correspond to any instance of the expected feature 44 in the digitized map 16, so the system 10 may not be able to quickly and/or reliably determine that the traffic-officer 50 is a person, i.e. is not permanent. In order for the system 10 to form a useful instance of the inquiry 30, the system 10 may include an identification-database 52 programmed into the memory 42 that includes a drill-down routine 54. For example, if information from the object-detection-device 24 suggests that the traffic-officer 50 is somewhat shaped like a human, then the inquiry may be based on a comparison of that information from the object-detection-device 24 to the identification-database 52. The inquiry from the drill-down routine may be—“Is that a person standing in the middle of the road?” If the operator 20 responds in the affirmative, the drill-down routine 54 may follow with—“Is the person directing traffic?” If the operator 20 responds in the negative, the drill-down routine 54 may ask—“Is that a temporary sign in the middle of the road?” Alternatively, the operator may respond to the first question with—“No. That is a police officer directing traffic.” This information may be used by the system 10 to determine when the digitized-map 16 should be updated.

By way of further explanation, the identification-database 52 is generally useful to determine an identity 56 of the object 26, e.g. determine if the object 26 is a building, construction barrier, dumpster, etc. In some instances it may be sufficient for the operator 20 to verbally identify the object 26, and other times it may be necessary for the system 10 to ask multiple questions using the drill-down routine to match the object 26 to some particular instance of the identity 56 related to the identification database 52. In other words, the system 10 is configured to output an inquiry 30 regarding the object 26 to the operator 20 via the operator-communication-device 28, and update the digitized-map 16 based on the response 32 from the operator 20.

As mentioned above, the system 10 may also be configured to determine when an expected-feature 44 present in the digitized-map 16 is not detected by the object-detection-device 24, output an inquiry 30 regarding the expected-feature 44 to the operator 20 via the operator-communication-device 28, and update the digitized-map 16 based on the response 32 from the operator 20. That is, the system 10 has a preplanned way to respond to the situation when the expected-feature 44 has disappeared. By way of example and not limitation, the digitized-map 16 may include the expected-feature 44 of a building that has been razed, so is now a razed-building 58, i.e. is missing and/or undetected by the object-detection-device 24.

In some instances the expected-feature 44 may be defined by relatively sparse data or the location is thought to include a large error, so the expected-feature 44 may include or be characterized by a confidence-level 60 in the digitized-map 16, and the controller 40 may be configured to update the confidence-level 60 based on the response 32 from the operator 20. By way of example and not limitation, the confidence-level 60 may be used as an indication of how reliably and/or accurately the expected-feature 44 is defined in the digitized-map. For example, the roadway 14 may be defined by lane-markings 62 that define the center of the roadway 14 or define a cross-walk on the roadway 14. Overtime, the lane-markings 62 may become faded or worn, so the confidence-level is decreased overtime. Then if the lane-markings 62 are repainted, which may include moving the lane-markings, then the system 10 may output an inquiry when the expected-feature 44 is in the digitized-map 16 with low confidence, but the lane-markings 62 suddenly seems to be easy to detect, so the object-detection-device is used in combination with the response 32 to confirm the expected-feature and thereby increase the confidence-level 60. This process may include the inquiry 30 of—“Do the lane-markings appear to have been recently repainted?” If the operator 20 responds in the affirmative, the system 10 may increase the confidence level 60.

As mentioned above, the system includes a memory 42 to store the digitized-map 16, and the inquiry 30 may be used to determine a classification 66 of the object as one of permanent, temporary, and mobile. By way of example, ‘permanent’ may be used when the object 26 expected to be present for a long time into the future. A rail-road track 68 is a suitable example of a permanent object. The classification 66 may be ‘temporary’ when the object 26 is expected to be present next week but not present a year from now. A construction-barrier 72 is a suitable example of a temporary object. The classification 66 may be ‘mobile’ when object expected to gone tomorrow. A stalled-truck 74 is a suitable example of a mobile object.

The classification 66 may also be useful to determine an action by the system 10 when a previously detected object disappears. If the object is classified as permanent object, the system 10 may issue an inquiry 30 if the permanent object is not detected. However, if the classification 66 was temporary or mobile, the system 10 may update the digitized map 16 without the confirmation provided by the system 10 receiving the response 32 from the operator 20.

As part of ‘gamification’ of the system 10, a reward 76 may be issued based on the response 32 from the operator 20. That is, the reward 76 may be intended to encourage the operator 20 to respond to the inquiry 30 in a helpful manner. The reward 76 may be, but is not limited to, discounts on future auto-taxi rentals, free-coffee at a partner business, merely a note of appreciate sent to the operator 20.

Accordingly, a map-update system (the system 10), a controller 40 for the system 10 and a method of operating the system 10 are provided. Making use of the presence of a human (the operator 20) to act as a high-intelligence confirmation tool of the digitized-map 16 provides an inexpensive way to keep the digitized map 16 and the map database 64 up to date.

While this invention has been described in terms of the preferred embodiments thereof, it is not intended to be so limited, but rather only to the extent set forth in the claims that follow.

We claim:

1. A map-update system to update maps used by an automated vehicle, said system comprising:
an object-detection-device used to detect objects proximate to a vehicle;
an operator-communication-device used to communicate an inquiry to an operator and detect a response from the operator; and
a controller in communication with the object-detection-device and the operator-communication-device, said controller configured to navigate the vehicle in accordance with a digitized-map, determine when an object detected by the object-detection-device does not correspond to an expected-feature present in the digitized-map, output an inquiry regarding the object to the operator via the operator-communication-device, and update the digitized-map based on the response from the operator.

2. The system in accordance with claim 1, wherein the operator is one of a vehicle-occupant of the vehicle and a remote-operator operating the vehicle from a remote-location.

3. The system in accordance with claim 1, wherein the controller is configured to determine when an expected-feature present in the digitized-map is not detected by the object-detection-device, output an inquiry regarding the expected-feature to the operator via the operator-communication-device, and update the digitized-map based on the response from the operator.

4. The system in accordance with claim 1, wherein the expected-feature is characterized by a confidence-level in the digitized-map, and the controller is configured to update the confidence-level based on the response from the operator.

5. The system in accordance with claim 1, wherein the system includes a memory to store the digitized-map, and the inquiry is used to determine a classification the object as one of permanent, temporary, and mobile.

6. The system in accordance with claim 1, wherein the system includes a memory programmed with an identification-database, and the inquiry is based on a comparison of information from the object-detection-device to the identification-database.

7. The system in accordance with claim 1, wherein the system is configured to issue a reward based on the response from the operator.
